(19) United States
(12) Patent Application Publication
(10) Pub. No.: US 2014/0266713 A1
(43) Pub. Date: Sep. 18, 2014

(54) Predictive Maintenance For Medical Devices

(71) Applicant: CAREFUSION 303, INC., San Diego, CA (US)

(72) Inventors: Ritika Sehgal, San Diego, CA (US); Aron Weiler, San Diego, CA (US); Brian Sullivan, San Diego, CA (US)

(73) Assignee: CareFusion 303, Inc., San Diego, CA (US)

(21) Appl. No.: 13/826,786

(22) Filed: Mar. 14, 2013

(51) Int. Cl. G08B 23/00

(52) U.S. Cl. CPC G08B 23/00
USPC 340/540

(57) ABSTRACT

The subject matter disclosed herein provides methods for generating an alert to perform maintenance on a medical device based on actual usage of the medical device. In one aspect, the method can include measuring a parameter value for a parameter type. The parameter type can be associated with a component in a medical device connected to a network and related to a function performed by the component. The method can further include locally storing at the medical device the measured parameter value, the parameter type, and a first value that indicates when the measured parameter value was measured; accessing a maintenance threshold value that specifies a performance limit for the parameter type; comparing the maintenance threshold value with the measured parameter value; and generating an alert based on the comparing to indicate that maintenance is needed for the component. Related apparatus, systems, techniques, and articles are also described.

### TECHNICAL FIELD

The subject matter described herein relates to the maintenance of medical devices using a predictive maintenance program that generates maintenance alerts based on one or more usage parameters.

### BACKGROUND

Medical devices can be used to diagnose, prevent, and treat diseases and conditions in patients. In order to ensure that these devices are functioning properly, medical devices should be inspected and maintained throughout their lifespan. Regular maintenance may help keep medical devices in working order and prevent device failure.

A preventive maintenance program may be used to service medical devices in accordance with a predetermined schedule. These schedules may, for example, designate a future date at which maintenance should be performed on a device. For example, if a liquid crystal display (LCD) monitor on a device is known to have an average lifespan of five years, then a technician may service or replace an LCD monitor just before the five year mark.

The time based nature of preventive maintenance programs assumes that medical devices are used in accordance with standard averages. This generalization, however, may not reflect actual usage patterns and may result in maintenance that is performed too late. For example, with respect to the LCD monitor described above, if the monitor is continuously kept on for months at a time, then the monitor may require service or replacement much earlier than the average LCD monitor. Adherence to the five year maintenance schedule may result in maintenance that is performed too late.

Preventive maintenance may also result in the performance of unnecessary upkeep. For example, if a medical device that has been in storage for 5 years is brought out of storage, a preventive maintenance program may require replacement of various parts in the device before it can be reused. Parts replacement, however, may be unnecessary if the device was minimally used before being placed in storage. These unnecessary preventive routines can result in significant costs to a hospital.

### SUMMARY

In some implementations, methods and apparatus, including computer program products, and systems are provided for the generation of an alert to perform maintenance on a medical device based on actual usage of the medical device.

In one aspect, a parameter value for a parameter type is measured. The parameter type is associated with at least one component in a medical device connected to a network and related to a function performed by the at least one component. In addition, the measured parameter value, the parameter type, and a first value indicating when the measured parameter value was measured is locally stored at the medical device. A maintenance threshold value associated with the parameter type is accessed. The maintenance threshold value specifies a performance limit for the parameter type. The maintenance threshold value is compared with the measured parameter value. When the comparing indicates that maintenance is needed for the at least one component associated with the parameter type, an alert is generated.

The above methods, apparatus, computer program products, and systems can, in some implementations, further include one or more of the following features.

The generated alert can be displayed, stored, loaded, and transmitted to a remote computing system.

If there is more than one measured parameter value associated with the parameter type, then a most recently measured parameter value can be selected from one or more measured parameter values for the comparing. This selection can be based on a comparison of first values for the more than one measured parameter values.

The alert can be displayed on the medical device when the measured parameter value meets or exceeds the maintenance threshold value. The alert can display a suggested maintenance for the at least one component associated with the parameter type. The medical device or at least one component can be rendered inoperable until the suggested maintenance is performed.

The medical device can display the alert when the measured parameter value is less than the maintenance threshold value and equal to a predetermined percentage of the maintenance threshold value. Moreover, the alert can display an estimate of when maintenance will be needed and a suggested maintenance for the at least one component associated with the parameter type.

The alert can be transmitted to a server when the alert is generated and when the medical device is connected to the network. If the medical device is disconnected from the network when the alert is generated, the alert can be transmitted to the server upon request from the server.

The server can be configured to receive the alert from the medical device and push the alert to one or more client devices connected to the network. The server can be further configured to send the maintenance threshold value to the medical device.

The server can be further configured to store the alert in an alert log. The alert log can include one or more alerts from one or more medical devices connected to the network. In addition, the server can perform analytics on the one or more alerts stored in the alert log. The alert log can identify, for each of the one or more alerts, a medical device that sent the alert, at least one component affected by the alert, when the alert was generated, and a suggested maintenance for the affected at least one component. The alert log can further identify, for each of the one or more alerts, a department that uses the medical device. The analytics can include the determination of a frequency for which maintenance is needed by each department in a hospital.

The maintenance threshold value can be stored locally at the medical device.

The measuring, storing, accessing, comparing, and generating described above can be implemented by at least one data processor forming part of at least one computing system.

Computer program products are also described that comprise non-transitory computer readable media storing instructions, which when executed one or more data processor of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, in some implementations, a predictive maintenance program may alert an operator to suggested maintenance for a medical device based on actual usage of the medical device, thereby obviating unnecessary maintenance routines. In addition, the current subject matter can allow a hospital administrator to perform various analytics on the maintenance needs of various medical devices and hospital departments.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated herein and constitute a part of this specification, show certain aspects of the subject matter disclosed herein and, together with the description, help explain some of the principles associated with the subject matter disclosed herein. In the drawings,

FIG. 1 is a system diagram illustrating a computing landscape within a healthcare environment;

FIG. 2 is a block diagram of a medical device;

FIG. 3 is a table of parameters, parameter values, and other related data for different components in a medical device;

FIG. 4 is an alert log for alerts received from one or more medical devices in the network; and

FIG. 5 is a flowchart for generating an alert.

Like reference symbols in the various drawings indicate like elements.

### DETAILED DESCRIPTION

The subject matter disclosed herein relates to predictive maintenance of medical devices. In a predictive maintenance program, an operator of a medical device can receive an alert to perform maintenance on a medical device based on actual usage of the medical device. In an implementation of a predictive maintenance program, a medical device can be configured to track the activity of its internal components and compare various parameters associated with component activity to corresponding maintenance threshold values. As component activity reaches or exceeds a maintenance threshold value, the medical device can issue an alert to inform a user that maintenance is needed.

FIG. 1 is a system diagram illustrating a computing landscape 100 within a healthcare environment such as a hospital. Various devices and systems, both local to the healthcare environment and remote from the healthcare environment, can interact via at least one computing network 105. This computing network 105 can provide any form or medium of digital communication connectivity (i.e., wired or wireless) amongst the various devices and systems. Examples of communication networks include a local area network (“LAN”), a wide area network (“WAN”), and the Internet. In some cases, one or more of the various devices and systems can interact directly via peer-to-peer coupling (either via a hardwired connection or via a wireless protocol such as Bluetooth or WiFi). In addition, in some variations, one or more of the devices and systems communicate via a cellular data network.

In particular, aspects of the computing landscape 100 can be implemented in a computing system that includes a back-end component (e.g., as a data server 110), or that includes a middleware component (e.g., an application server 115), or that includes a front-end component (e.g., a client computer 120 having a graphical user interface or a Web browser through which a user may interact with an implementation of the subject matter described herein), or any combination of such back-end, middleware, or front-end components. A client 120 and servers 110 and 115 are generally remote from each other and typically interact through the communications network 105. The relationship of the clients 120 and servers 110, 115 arises by virtue of computer programs running on the respective computers and having a client-server relationship to each other. Clients 120 can be any of a variety of computing platforms that include local applications for providing various functionality within the healthcare environment. Example clients 120 include, but are not limited to, desktop computers, laptop computers, tablets, and other computers with touch-screen interfaces. The local applications can be self-contained in that they do not require network connectivity and/or they can interact with one or more of the servers 110, 115 (e.g., a web browser).

A variety of applications can be executed on the various devices and systems within the computing landscape such as electronic health record applications, medical device monitoring, operation, and maintenance applications, scheduling applications, billing applications and the like.

The network 105 can be coupled to one or more data storage systems 125. The data storage systems 125 can include databases providing physical data storage within the healthcare environment or within a dedicated facility. In addition, or in the alternative, the data storage systems 125 can include cloud-based systems providing remote storage of data in, for example, a multi-tenant computing environment. The data storage systems 125 can also comprise non-transitory computer readable media.

Mobile communications devices (MCDs) 130 can also form part of the computing landscape 100. The MCDs 130 can communicate directly via the network 105 and/or they can communicate with the network 105 via an intermediate network such as a cellular data network 135. Various types of communication protocols can be used by the MCDs 130 including, for example, messaging protocols such as SMS and MMS.

Various types of medical devices 140 can be used as part of the computing landscape 100. These medical devices 140 can comprise, unless otherwise specified, any type of device or system with a communications interface that characterizes one or more physiological measurements of a patient and/or that characterize treatment of a patient. In some cases, the medical devices 140 communicate via peer to peer wired or wireless communications with another medical device 140 (as opposed to communicating with the network 105). For example, the medical device 140 can comprise a bedside vital signs monitor that is connected to other medical devices 140, namely a wireless pulse oximeter and to a wired blood pressure monitor. One or more operational parameters of the medical devices 140 can be locally controlled by a clinician, controlled via a clinician via the network 105, and/or they can be controlled by one or more of a server 110 and/or 115, a client 120, a MCD 130, and/or another medical device 140.

The computing landscape 100 can provide various types of functionality as may be required within a healthcare environment such as a hospital. For example, a pharmacy can initiate a prescription via one of the client computers 120. This prescription can be stored in the data storage 125 and/or pushed out to other clients 120, an MCD 130, and/or one or more of the medical devices 140. In addition, the medical devices 140 can provide data characterizing one or more physiological measurements of a patient and/or treatment of a patient (e.g., medical device 140 can be an infusion management system, etc.). The data generated by the medical devices 140 can be communicated to other medical devices 140, the servers 110 and 115, the clients 120, the MCDs 130, and/or stored in the data storage systems 125.

FIG. 2 illustrates a block diagram of a medical device 140 that can correspond to any of the medical devices illustrated in FIG. 1. Medical device 140 can have components 205A, 205B, and 205C that can be used during operation of the medical device. For example, medical device 140 can correspond to a peristaltic pump, and components 205A, 205B, and 205C can correspond to pumping fingers associated with the peristaltic pump. These pumping fingers can be configured to move in accordance with a predetermined pattern to move medication/fluid through the pump.

Each of the components 205A, 205B, and 205C in medical device 140 can be connected to a sensor. In the implementation of FIG. 2, components 205A, 205B, and 205C can be connected to sensors 210A, 210B, and 210C, respectively. Although each component is connected to its own sensor in FIG. 2, other configurations can be used including, for example, the use of one or more shared sensors.

Each sensor can measure various parameters associated with the component that it is connected to. These parameters can include, for example, how long the component remains on, whether the component is in an idle state or active state while on, how long the component remains in an active state while on, whether the component is moving, the speed and distance at which the component moves, and the like.

The parameters measured by sensors 210A, 210B, and 210C can be related to the functionality and/or use of the component 205A, 205B, and 205C. For example, if components 205A, 205B, and 205C correspond to the pumping fingers of a peristaltic pump, sensors 210A, 210B, and 210C can measure the duration of time that each pumping finger is in motion. These time related parameter values can be measured over the lifespan of each component (lifecycle runtime), during each individual session (session runtime), or both. If the peristaltic pump is battery operated, then sensor 210A can also record the number of times that the battery of the pump charges and discharges as well as its charge time and how long the battery remains on. In another example, if medical device 140 is a syringe, and component 205B is a plunger in the syringe, then sensor 210B can measure the number of times the syringe's plunger is moved. In yet another example, if component 205C is a touch sensitive display screen, then sensor 210C can record the number of hours that the screen remains on over the lifespan of the display screen and/or the number of times a particular area of the screen is pressed. In a further example, one of the components 205A, 205B, 205C can be a door of an infusion pump and one or more of the sensors 210A, 210B, 210C can measure the number of times the door opens and closes (and such information can be used to characterize how much the infusion pump has been used as described below).

Medical device 140 can store the data collected by sensors 210A, 210B, and 210C in table 300 illustrated in FIG. 3. Table 300 can be stored in memory 215 and can identify the component 310 in the medical device that is under observation, the parameter type 315 that is measured, the value 320 of the parameter measurement, and the date/time 325 that the parameter is measured.

Alternatively or in addition to locally storing sensor data in memory 215, medical device 140 can transmit sensor data across network 105 and store the sensor data in data storage 125. Medical device 140 can automatically push live sensor data across network 105 when connected to the network. This data push can occur in real time as the sensor data is generated, at preset intervals, or upon the occurrence of a particular event. This data push can occur either before or after sensor data is stored in memory 215. If medical device 140 is disconnected from network 105 and later connected to the network, the medical device can push live sensor data to data storage 125 as it is generated by sensors 210A, 210B, and 210C. With regard to any historical data that is generated by sensors 210A, 210B, and 210C while medical device 140 is offline, medical device 140 can transmit this data from local memory 215 to storage device 125 upon request from a server running a predictive maintenance application, such as application server 115. Application server 115 can query medical device 140 for historical data upon determining that sensor data is missing for a given period of time. Application server 115 can make this determination by examining time stamps associated with sensor data generated by sensors 210A, 210B, and 210C.

As components 205A, 205B, and 205C experience wear and tear from day-to-day use, these components can require maintenance. Processor 220 in medical device 140 can be configured to determine whether maintenance is required by comparing a measured parameter value 320 for a component with a corresponding maintenance threshold value. Application server 115 can transmit maintenance threshold values to medical device 140 which, in turn, can store this data in memory 215.

Maintenance threshold values can specify when maintenance should be performed on a component in a medical device. Each maintenance threshold value can be associated with a parameter measured by a component's sensor. For example, if component 205A corresponds to a plunger in a syringe, and sensor 210A measures how many times the plunger in the syringe moves, then the corresponding maintenance threshold value can indicate the maximum number of times that the plunger can move before the syringe should be serviced or replaced. In another example, if component 205B corresponds to a motor in an infusion pump, and sensor 210B measures the distance that the motor turns to pump medication, then the corresponding maintenance threshold value can indicate the maximum distance that the motor can turn before motor service should be performed. Maintenance threshold data can, for example, be determined by a manufacturer of the medical device using historical test data.

Referring to the data stored in table 300, processor 220 can compare a measured parameter value 320 for a parameter type 315 to a maintenance threshold value of the same parameter type 315. If there is more than one parameter value 320 for each parameter type 315, then processor 220 can select the most recently measured parameter value based on date/time entries 325. For example, in table 300, there are three entries for a parameter type corresponding to the number of hours that a touch screen has been continuously in use. In this example, processor 220 can compare date/time values 325 for the three entries and select the measured parameter value that was most recently measured (i.e., measured parameter value 3.2 hours) for comparison with the maintenance threshold value.

Based on this comparison, processor 220 can generate an alert to be displayed on display 230 of medical device 140 when the measured parameter value 320 meets or exceeds the corresponding maintenance threshold value. When these conditions are met, the medical device 140 or the affected component can be automatically turned off or otherwise rendered inoperable until the suggested maintenance is performed. The alert can also display the affected component and the suggested maintenance for the affected component.

In some implementations, processor 220 can be configured to generate an alert to be displayed on display 230 before the maintenance threshold value is reached. This can occur at one or more predetermined levels including, for example, when the measured parameter value 320 reaches 75% or 90% of a corresponding maintenance threshold value. In these implementations, the alerts can indicate, for example, that maintenance can soon be required for a particular component and the suggested maintenance. In some implementations, these alerts can also provide an estimate of when maintenance will be needed for the component. This estimate can be based on component usage patterns that can be derived from measured parameter values 320. In some implementations, these alerts can increase in frequency as measured parameter values 320 near the maintenance threshold value and can require the user to take action.

Alternatively or in addition to displaying an alert at medical device 140, the medical device can also transmit the alert when it is generated across network 105 to application server 115 when the medical device is connected to the network. If medical device 140 is disconnected from network 105 and later connects to the network, the medical device can transmit any alerts that were generated while the medical device was offline to application server 115 upon request from the application server.

Upon receiving this alert, application server 115 can push the alert to clients 120 and/or MCD 130 via a notification system. The notification system can be configured to push the alert to a pre-determined subset of clients 120 and MCD 130 or all of these devices depending on the criticality of the alert. Pushing an alert through a notification system allows an operator using clients 120 and/or MCD 130 to remotely view the alert on his/her device without requiring the user to be at medical device 140.

In addition to pushing a received alert via the notification system, application server 115 can also separately store the alert in an alert log. FIG. 4 illustrates an alert log 400 that can reside in data storage 125. Alert log 400 can have a list of alerts that can be received from all medical devices 140 attached to network 105. For each alert, alert log 400 can specify the medical device 405 that sent the alert, the affected component 410, the hospital department 415 that uses the medical device, the date/time 420 that the alert was generated, and the suggested maintenance 425 displayed in the alert.

Application server 115 can perform analytics on the data stored in alert log 300 or the raw sensor data transmitted from medical device 140 for trending purposes. In an implementation, application server 115 can determine the frequency for which maintenance is required for medical devices in each hospital department. This information can be determined by sorting alert log 400 by hospital department 415 and calculating the rate at which alerts are received in each department using the data in date/time column 420. These frequency values can be compared across all hospital departments to determine, for example, which department requires the most maintenance or service for their medical devices. The granularity of the analytics can be adjusted by performing this analysis for a specific type of medical device (using the information in column 405) or for a specific component in a medical device (using the information in column 410). Based on these analytics, healthcare providers can determine whether particular medical devices or components are running within well-defined ranges. Other analytics can be performed including, for example, determining the type of maintenance most commonly suggested for a component (using the data in columns 410 and 425) in a medical device and the like. These analytics can also help healthcare providers plan their equipment inventory in view of anticipated downtime.

FIG. 5 illustrates a flowchart for generating an alert. At 505, a parameter value for a parameter type associated with at least one component can be measured. The component(s) can, for example, correspond to a display on a medical device 140, and the parameter type can correspond to the number of hours that the display has been in continuous use. One or more of sensors 210A, 210B, and 210C in medical device 140 can perform this measurement.

At 510, the measured parameter value, the parameter type, and a first value indicating when the measured parameter value was measured can be locally stored. This information can, for example, correspond to the information in table 300 and can be stored in memory 215 of medical device 140. Table 300 can include multiple entries for the parameter type 315 (i.e., the number of hours that the medical device display has been in continuous use). Each of these entries can have a date/time value 325 that indicates when the measurement was taken.

At 515, a maintenance threshold value associated with the parameter type can be accessed. Medical device 140 can, for example, receive this maintenance threshold value via a transmission from application server 115 across network 105 and/or it can access the maintenance threshold value from local memory. The received maintenance threshold value can have the same parameter type as the measured parameter values in table 300. In the instant example, the maintenance threshold value can represent the maximum number of hours that a medical device display can be in continuous use.

At 520, the maintenance threshold value can be compared with the measured parameter value. Processor 220 in medical device 140 can perform this comparison. In the instant example, if there are multiple entries for the number of continuous hours that the medical device display has been in continuous use, then processor 220 can select the most recently measured parameter value for comparison with the maintenance threshold value.

At 525, an alert can be generated for display on medical device 140 based on the comparison performed at 520. This alert can, for example, indicate that the display on medical device 140 needs service. The alert can be provided in a variety of manners. For example, the alert can be stored, loaded into memory, transmitted and/or displayed. In particular, the alert can be displayed when the measured parameter value is less than, meets or exceeds the maintenance threshold value.

One or more aspects or features of the subject matter described herein can be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A method comprising:
measuring a parameter value for a parameter type, the parameter type associated with at least one component in a medical device connected to a network and related to a function performed by the at least one component;
locally storing at the medical device the measured parameter value, the parameter type, and a first value indicating when the measured parameter value was measured;
accessing a maintenance threshold value associated with the parameter type, the maintenance threshold value specifying a performance limit for the parameter type;
comparing the maintenance threshold value with the measured parameter value; and
generating an alert based on the comparing indicating that maintenance is needed for the at least one component associated with the parameter type.

2. The method as in claim 1, further comprising at least one of displaying the alert, storing the alert, loading the alert, and transmitting the alert to a remote computing system.

3. The method of claim 1, further comprising:
selecting a most recently measured parameter value from one or more measured parameter values for the comparing if there is more than one measured parameter value associated with the parameter type, the most recently measured parameter value selected based on a comparison of first values for the more than one measured parameter values.

4. The method of claim 1, wherein the alert is displayed on the medical device when the measured parameter value meets or exceeds the maintenance threshold value, the alert displaying a suggested maintenance for the at least one component associated with the parameter type.

5. The method of claim 4, further comprising:
rendering the medical device or at least one component inoperable until the suggested maintenance is performed.

6. The method of claim 1, wherein the alert is displayed on the medical device when the measured parameter value is less than the maintenance threshold value and equal to a predetermined percentage of the maintenance threshold value, the alert displaying an estimate of when maintenance will be needed and a suggested maintenance for the at least one component associated with the parameter type.

7. The method of claim 1, further comprising:
transmitting the alert to a server when the alert is generated and when the medical device is connected to the network.

8. The method of claim 7, further comprising:
transmitting the alert to the server upon request from the server if the alert is generated when the medical device is disconnected from the network.

9. The method of claim 7, wherein the server is configured to receive the alert from the medical device and push the alert to one or more client devices connected to the network.

10. The method of claim 7, wherein the server is further configured to send the maintenance threshold value to the medical device.

11. The method of claim 7, wherein the server is further configured to:
store the alert in an alert log, the alert log including one or more alerts from one or more medical devices connected to the network; and
perform analytics on the one or more alerts stored in the alert log;
wherein the alert log identifies, for each of the one or more alerts, a medical device that sent the alert, at least one component affected by the alert, when the alert was generated, and a suggested maintenance for the affected at least one component.

12. The method of claim 11, wherein:
the alert log further identifies, for each of the one or more alerts, a department that uses the medical device, and
the analytics include determining a frequency for which maintenance is needed by each department in a hospital.

13. The method of claim 1, wherein the maintenance threshold value is stored locally at the medical device.

14. The method of claim 1, wherein one or more of the measuring, storing, accessing, comparing, and generating are implemented by at least one data processor forming part of at least one computing system.

15. A non-transitory computer-readable medium containing instructions to configure a processor to perform operations comprising:
measuring a parameter value for a parameter type, the parameter type associated with at least one component in a medical device connected to a network and related to a function performed by the at least one component;
locally storing at the medical device the measured parameter value, the parameter type, and a first value indicating when the measured parameter value was measured;
accessing a maintenance threshold value associated with the parameter type, the maintenance threshold value specifying a performance limit for the parameter type;
comparing the maintenance threshold value with the measured parameter value; and
generating an alert based on the comparing indicating that maintenance is needed for the at least one component associated with the parameter type.

16. The non-transitory computer-readable medium of claim 15, wherein the alert is displayed on the medical device when the measured parameter value meets or exceeds the maintenance threshold value, the alert displaying a suggested maintenance for the at least one component associated with the parameter type.

17. The non-transitory computer-readable medium of claim 15, further comprising:
transmitting the alert to a server when the alert is generated and when the medical device is connected to the network.

18. A system comprising:
a processor; and
a memory, wherein the processor and the memory are configured to perform operations comprising:
measuring a parameter value for a parameter type, the parameter type associated with at least one component in a medical device connected to a network and related to a function performed by the at least one component;
locally storing at the medical device the measured parameter value, the parameter type, and a first value indicating when the measured parameter value was measured;
accessing a maintenance threshold value associated with the parameter type, the maintenance threshold value specifying a performance limit for the parameter type;
comparing the maintenance threshold value with the measured parameter value; and
generating an alert based on the comparing indicating that maintenance is needed for the at least one component associated with the parameter type.

19. The system of claim 18, the operations further comprising:
transmitting the alert to a server when the alert is generated and when the medical device is connected to the network.

20. The system of claim 19, wherein the server is further configured to:
store the alert in an alert log, the alert log including one or more alerts from one or more medical devices connected to the network; and
perform analytics on the one or more alerts stored in the alert log;
wherein the alert log identifies, for each of the one or more alerts, a medical device that sent the alert, at least one component affected by the alert, when the alert was generated, and a suggested maintenance for the affected at least one component.
